(19) United States
(12) Patent Application Publication
(10) Pub. No.: US 2006/0291414 A1
(43) Pub. Date: Dec. 28, 2006

(54) Method and system for performing initial operation in a frequency overlay communication system

(75) Inventors: Eun-Taek Lim, Suwon-si (KR); Jung-Min Ro, Seoul (KR); Jae-Hyuk Jang, Suwon-si (KR); Young-Bin Chang, Hwaseong-si (KR); Chang-Ho Suh, Seongnam-si (KR); Young-Kyun Kim, Seongnam-si (KR); Dong-Seek Park, Yongin-si (KR); Young-Kwon Cho, Suwon-si (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Suwon-si (KR)

(21) Appl. No.: 11/476,986

(22) Filed: Jun. 28, 2006

(30) Foreign Application Priority Data
Jun. 28, 2005 (KR) 56334/2005
Jul. 19, 2005 (KR) 65321/2005

(51) Int. Cl. H04Q 7/00; H04J 3/24

(52) U.S. Cl. 370/329; 370/349

(57) ABSTRACT

A method for performing an initial operation of a mobile station (MS) that uses a first frequency band, in a frequency overlay communication system having the first frequency band including a plurality of sub-frequency bands. The method includes performing correlation on a full frequency band in units of the first frequency band, receiving broadcast information through a frequency band having a maximum correlation value, and performing an initial access to a base station (BS) through the frequency band having the maximum correlation value if a frequency bandwidth of the BS acquired from the broadcast information is narrower than or equal to a selected frequency bandwidth of the MS.

### PRIORITY

This application claims the benefit under 35 U.S.C. § 119(a) of an application entitled “Method and System for Performing Initial Operation in a Frequency Overlay Communication System” filed in the Korean Intellectual Property Office on Jun. 28, 2005 and assigned Serial No. 2005-56334, and an application entitled “Method and System for Performing Initial Operation in a Frequency Overlay Communication System” filed in the Korean Intellectual Property Office on Jul. 19, 2005 and assigned Serial No. 2005-65321, the contents of both of which are incorporated herein by reference.

### BACKGROUND OF THE INVENTION

1. Field of the Invention

The present invention relates generally to a method and system for performing an initial operation in a communication system, and in particular, to a method and system for performing an initial operation in a frequency-overlaid communication system (hereinafter frequency overlay communication system).

2. Description of the Related Art

The rapid development of communication systems and the diverse services provided in these systems have created the need for a broadband communication system supporting broadband service. Generally, communication systems have limited frequency resources, and broadband communication systems have a limited number of available frequency bands.

The current broadband communication systems were designed on the assumption that they would use different frequency bands. However, the increasing demand for frequency bands for the broadband service due to the rapid development of the communication technology increases the license cost for the frequency bands, making it impossible to use the various available schemes proposed to provide the broadband service.

As a result, there is a need for a scheme for efficiently providing broadband service while solving the high license cost problem for the frequency bands. One such scheme involves a broadband communication system which is frequency-overlaid with the existing communication system in a particular frequency band. In this case, a mobile station (MS) of the broadband communication system and an MS of the existing communication system may coexist either in the existing communication system or in the broadband communication system. Accordingly, there is a need to define an initial operation such that the users (or MSs) may access a particular system and register therein to perform communication.

### SUMMARY OF THE INVENTION

It is, therefore, an object of the present invention to provide a method and system for performing an initial operation regardless of a bandwidth used by a base station (BS) in a frequency overlay communication system.

It is another object of the present invention to provide a method and system for performing an initial operation considering a frequency diversity gain in a frequency overlay communication system.

According to the present invention, a method for performing an initial operation of a mobile station (MS) that uses a first frequency band, in a frequency overlay communication system having the first frequency band including a plurality of sub-frequency bands, includes performing correlation on a full frequency band in units of the first frequency band, receiving broadcast information through a frequency band having a maximum correlation value, and performing an initial access to a BS through the frequency band having the maximum correlation value if a frequency bandwidth of the BS acquired from the broadcast information is narrower than or equal to a frequency bandwidth of the MS.

According to the present invention, a method for performing an initial operation of an MS that uses any selected one of sub-frequency bands, in a frequency overlay communication system having a first frequency band including a plurality of the sub-frequency bands having different center frequencies, includes performing correlation on a full frequency band in units of the selected one sub-frequency band, receiving broadcast information through a sub-frequency band having a maximum correlation value, and sending a ranging request to a BS using band information acquired from the broadcast information.

According to the present invention, there is provided a system for performing an initial access in a frequency overlay communication system, including a BS using at least one first frequency band, for broadcasting load information indicating the amount of consumed resources for each of at least one sub-frequency band, wherein the first frequency band is a broad frequency band and includes at least one sub-frequency band which is a narrow frequency band, and an MS for determining any one sub-frequency band in the first frequency band taking into account the load information received from the BS.

According to the present invention, there is provided a method for performing an initial access of an MS in a frequency overlay communication system having at least one first frequency band which is a broad frequency band and includes at least one sub-frequency band which is a narrow frequency band, including receiving, from a BS, load information indicating the amount of consumed resources for each of the least one sub-frequency band, determining any one sub-frequency band in the first frequency band taking the load information into account, and performing an initial access to the BS through the determined sub-frequency band.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating a frequency allocation operation in a frequency overlay communication system according to the present invention;

FIG. 2 is a diagram illustrating a transceiver module used in an EB communication system according to the present invention;

FIG. 3 is a diagram illustrating an alternative exemplary transceiver module used in an extended band (EB) communication system according to the present invention;

FIG. 4 is a diagram illustrating a format of a downlink frame in a frequency overlay communication system according to the present invention;

FIG. 5 is a flowchart illustrating an initial operation performed by an MS in a frequency overlay communication system according to a first embodiment of the present invention;

FIG. 6 is a signaling diagram illustrating a message flow for an initial operation in a frequency overlay communication system according to the first embodiment of the present invention;

FIG. 7 is a flowchart illustrating a first initial access process performed by an MS in a frequency overlay communication system according to a second embodiment of the present invention;

FIG. 8 is a flowchart illustrating a second initial access process performed by an MS in a frequency overlay communication system according to the second embodiment of the present invention; and

FIG. 9 is a diagram illustrating a format of FAB load information according to the present invention.

### DETAILED DESCRIPTION OF THE PREFERRED EMBODIMENTS

Preferred embodiments of the present invention will now be described in detail with reference to the annexed drawings. In the following description, a detailed description of known functions and configurations incorporated herein has been omitted for the sake of clarity and conciseness.

The present invention provides a method and system for performing an initial operation for MSs that use an overlaid frequency band or a non-overlaid frequency band in a frequency overlay communication system.

In the following description, for convenience, an MS using the non-overlaid frequency band will be referred to as a “Narrow Band-Mobile Station (NB-MS),” and an MS using an extended frequency band including the non-overlaid frequency band will be referred to as an “Extended Band-Mobile Station (EB-MS).” In addition, a base station (BS) providing the non-overlaid frequency band will be referred to as a “Narrow Band-Base Station (NB-BS),” and a BS providing an extended frequency band including the non-overlaid frequency band will be referred to as an “Extended Band-Base Station (EB-BS).” When the EB-MS is located in an EB-BS that uses a further extended frequency band broader than the possible frequency band used by the EB-MS, the EB-MS becomes an NB-MS from the viewpoint of the EB-BS.

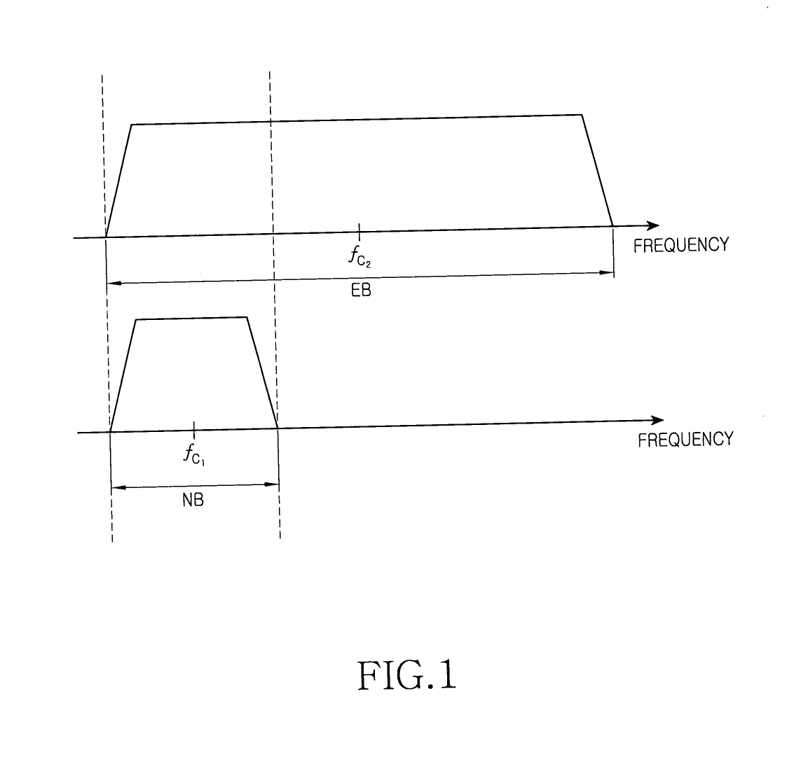

FIG. 1 is a diagram illustrating a frequency allocation operation in a frequency overlay communication system according to the present invention.

Referring to FIG. 1, the existing communication system is a narrow band (NB) communication system having a center frequency f_{c1}. In some situations, the NB communication system needs to extend its frequency band due to the diversification of services and the increase in the required transmission capacity. Therefore, a communication system with an extended frequency bandwidth (hereinafter EB communication system) can be considered, and can be designed such that it is overlaid with the NB communication system in the frequency band. In FIG. 1, therefore, the EB communication system has a center frequency f_{c2}. Herein, the NB communication system has a frequency band that is relatively narrower than the frequency bandwidth used in the EB communication system, and its frequency band is not absolutely narrow. The reasons for extending the frequency bandwidth using the frequency overlay scheme are as follows:

(1) For Reduction in License Cost for Frequency Band

In a new communication system, deployment of a frequency band being different from the frequency band used in the NB communication system not using the frequency overlay scheme causes an additional license cost for the frequency bands, similar to when the new communication system uses a new frequency band. However, the use of the frequency overlay scheme requires only the additional license cost for the additionally increased bandwidth, and not for the existing frequency band. As a result, the burden of the license cost for the frequency bands on the service providers decreases.

(2) For Increase in Frequency Resource Efficiency in Overlay Frequency Band

The use of the frequency overlay scheme increases frequency resource efficiency in the overlaid frequency band. The frequency resource efficiency is very important because service providers can benefit from their subscribers in proportion to the frequency resource efficiency.

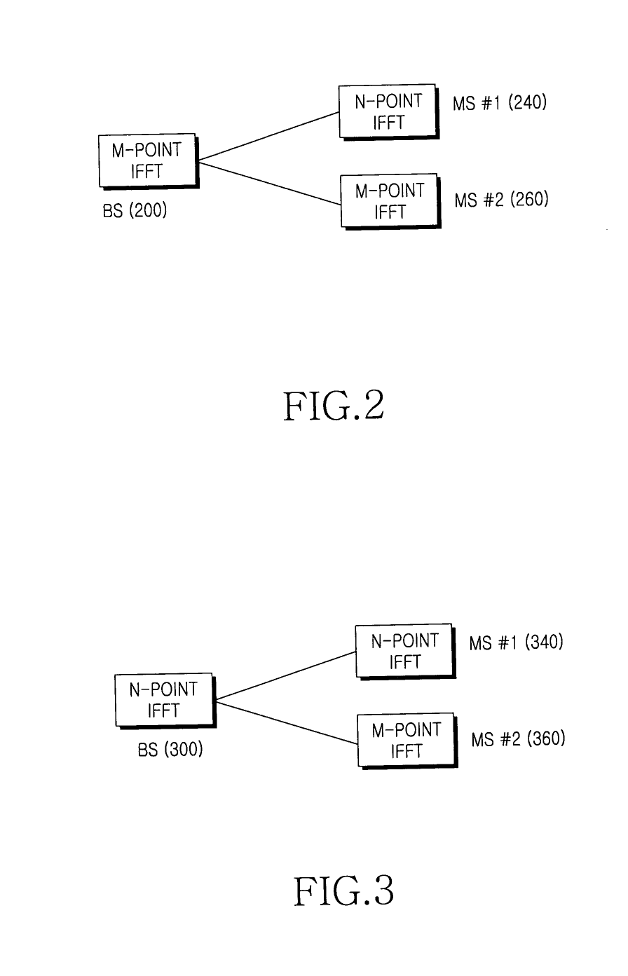

FIG. 2 is a diagram schematically illustrating a transceiver module used in an EB communication system according to the present invention.

It is assumed in FIG. 2 that the number of Inverse Fast Fourier Transform (IFFT)/Fast Fourier Transform (FFT) points of a transceiver module used in a communication system before a bandwidth of its frequency band in use is extended, i.e., an NB communication system, is N, and the number of IFFT/FFT points of a transceiver module used in a communication system after a bandwidth of its frequency band in use is extended, i.e., an EB communication system, is M (where M>N).

A BS 200 can support services to an MS#1 240 of the NB communication system and an MS#2 260 of the EB communication system simply with an M-point IFFT/FFT module without separately including an N-point IFFT/FFT module. In order to support services to the MSs of both the NB communication system and the EB communication system with only one IFFT/FFT module, i.e. the M-point IFFT/FFT module, it is necessary to provide a guard band between boundary frequency bands of the respective NB and EB communication systems. A specific size of the guard band depends upon performance of a band-pass filter (BPF).

FIG. 3 is a diagram illustrating an alternative transceiver module used in an EB communication system according to the present invention.

Similarly, it is assumed in FIG. 3 that the number of IFFT/FFT points of a transceiver module used in the NB communication system is N, and the number of IFFT/FFT points of a transceiver module used in the EB communication system is M (where M>N).

On the contrary, however, when the system is extended, it is preferable to deploy BSs that use the frequency overlay scheme. In this case, however, the BSs using the frequency overlay scheme may not be deployed in a particular region. In this region, the BSs with an N-point IFFT/FFT module used in the existing NB communication system are deployed.

After the system extension is completed, there is almost no case where only the NB-BSs are deployed in a particular region. However, in the course of the system extension, such cases inevitably occur. Therefore, unlike the BS of FIG. 2, if the BS of FIG. 3 is an NB-BS, then it should consider even the IFFT/FFT points of the transceiver module used in the EB communication system.

An NB-BS 300 uses only an N-point IFFT/FFT module. As described with reference to FIG. 2, if there is only the guard band between the frequency bands used in the respective EB and NB communication systems, the NB-BS 300 can communicate not only with an MS#1 340 having an N-point IFFT/FFT module, but also with an MS#2 360 having an M-point IFFT/FFT module, using only the N-point IFFT/FFT module. Also, as described with reference to FIG. 2, a specific size of the guard band depends upon performance of a BPF, and a detailed description of the guard interval will not be given.

However, communication is possible between an M (=2^{m}×N)-point IFFT module of the EB communication system and an N-point FFT module of the NB-communication system for the following reasons.

For example, it is assumed that a signal desired by a receiver is mapped only to the N-point part in the 2^{m}×N-point IFFT module. Next, the data output from the M-point IFFT module is up-converted to a band of a carrier frequency f_{c1} used in the NB communication system through a band-pass filtering process. Thereafter, the band-pass filtering is performed considering the bandwidth WEB occupied by the 2^{m}×N points. The BPF-processed data is transmitted via a transmission antenna Tx_Ant.

In a downlink, an NB-MS corresponding to a receiver receives the signal transmitted from the transmitter, i.e. the BS, via a reception antenna Rx_Ant. Thereafter, the NB-MS performs band-pass filtering over a bandwidth W_{NB} occupied by the N points. Due to the band-pass filtering over the bandwidth W_{NB}, the NB-MS can restore the data transmitted with an M (=2^{m}×N)-point IFFT module by the BS, with the N-point FFT module instead of a 2^{m}×N-point FFT module. The BPF-processed signal can be restored to its original signal using the N-point FFT module. That is, the NB-MS acquires information on the resource allocated thereto depending on a control signal, and then restores the traffic signal.

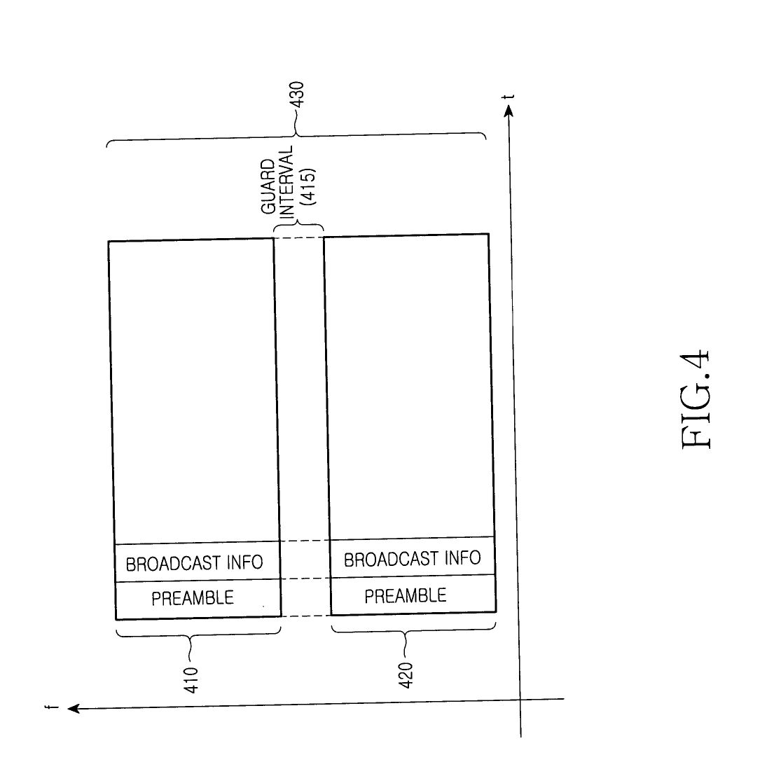

FIG. 4 is a diagram illustrating a format of a downlink frame in a frequency overlay communication system according to the present invention.

Referring to FIG. 4, an NB-BS can use one of frequency bands 410 or 420, and an EB-BS can use the full frequency band 430 composed of the frequency bands 410 and 420 and a guard interval 415. If the frequency band 430 of the EB-BS is defined as frequency allocation (FA), the FA 430 includes two FA blocks 410 and 420. Herein, each FA block will be referred to as “FAB,” and the FA and FAB are applied in the same manner even to the MS. The FAB indicates a unit frequency band that can be allocated to the MS or BS, and the FA is composed of at least one FAB. For example, when one FA is composed of one FAB, a communication system using the FA becomes an NB communication system. However, when one FA is composed of more than two FABs, a communication system using the FA becomes an EB communication system. The FAB 410 and the FAB 420 differ in their center frequencies, and the FA 430 and each of the FABs 410 and 420 also differ in their center frequencies.

Describing a preferred relationship between the FA and the FAB, when a BS uses an 80 MHz frequency band, the 80 MHz frequency band can be divided into 8 FABs, each of which is a 01 MHz frequency band. The 80 MHz frequency band becomes an FA, and if it is divided in 40 MHz frequency bands, it can be determined that the FA is composed of 2 FABs each having a 40 MHz frequency band. In addition, each of the 40 MHz frequency bands can be divided into FA1 and FA2, and each of the FA1 and FA2 can be divided into two FABs having a 20 MHz frequency band, or 4 FABs having a 10 HMz frequency band. If the BS uses only the 10 MHz frequency band, which is the unit frequency band, the 10 MHz frequency band serves as both an FAB and an FA. That is, the relationship between the FA and the FAB depends on its definition. The same can be applied even to the MS.

The MS may initially access to a BS having a broader, identical or narrower frequency bandwith than its own frequency bandwidth.

A description will now be made of an initial operation in which an NB-MS or an EB-MS accesses an NB-BS or an EB-BS and performs a registration procedure according to the present invention. Herein, the “initial operation” refers to the process performed from the time when an NB-MS or an EB-MS is powered until the time when NB-MS or an EB-MS operates in an idle mode.

Prior to the description, there is a need to provide the following hypotheses for the initial operation.

(1) A sub-carrier spacing used by an NB-BS should be equal to a sub-carrier spacing used by an EB-BS.

(2) An NB-MS or an EB-MS should not only be able to distinguish a center frequency of a BS, but also be able to distinguish whether the BS is an NB-BS or an EB-BS.

(3) The information broadcast by a BS should be transmitted over all FABs. That is, the broadcast information should be transmitted over all FABs such that the information broadcast by an EB-BS can be received even at the NB-MS using only a particular FAB.

(4) An NB-BS or an EB-BS should distinguish whether a particular MS is an NB-MS or an EB-MS, when the MS attempts an access thereto or performs scheduling on the MS, and should also distinguish a requested service type.

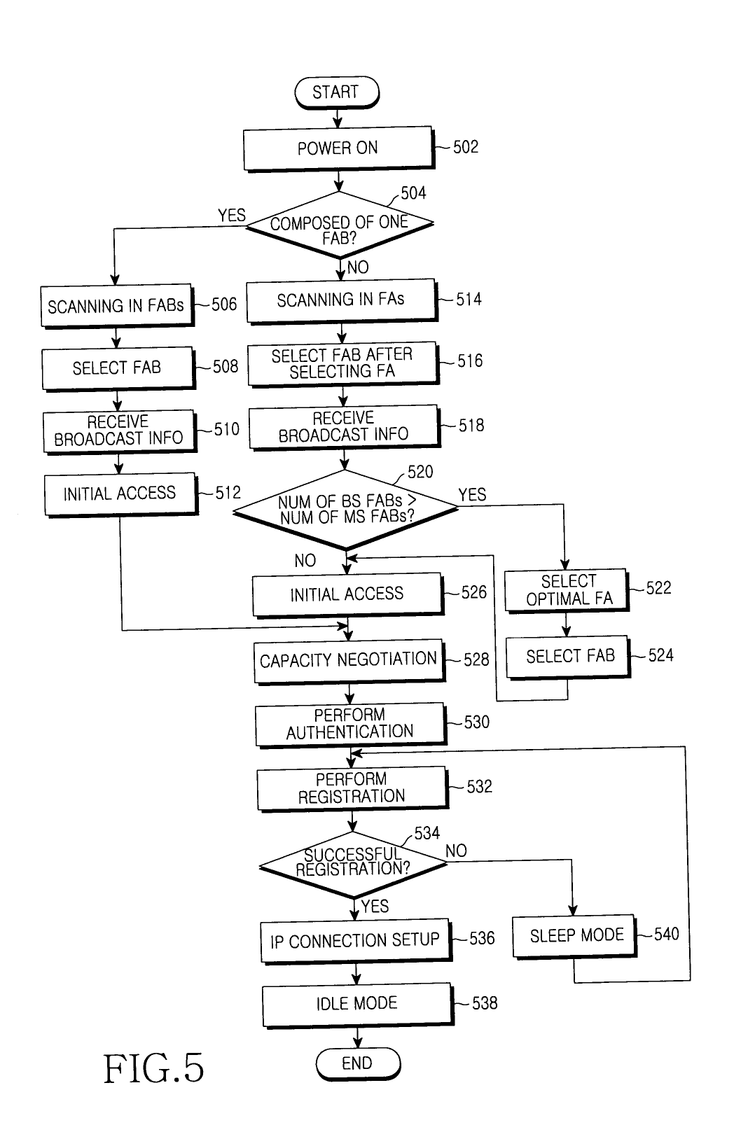

FIG. 5 is a flowchart illustrating an initial operation performed by an MS in a frequency overlay communication system according to a first embodiment of the present invention.

Referring to FIG. 5, in step 502, the MS is powered on. If it is determined in step 504 that a frequency band used by the MS is composed of one FAB, the MS proceeds to step 506, and if the frequency band is composed of at least two FABs, the MS proceeds to step 514.

In step 506, the MS scans the full frequency band in units of FABs regardless of whether a BS to which it will make an access is an NB-BS or an EB-BS. In step 508, if the MS selects a frequency band having the highest correlation as a result of the scanning, it recognizes a BS associated with a corresponding frequency band, and selects an FAB for the BS. In step 510, the MS receives broadcast information from the selected BS. In this case, the broadcast information includes system parameter information of the BS, downlink/uplink information, and position information necessary for an initial access to the BS, i.e. frame time slot information and frequency band information. In step 512, the MS performs an initial access to the BS using the position information acquired through the broadcast information.

In step 514, the MS scans the full frequency band in units of FAs. In step 516, the MS selects a BS having the highest correlation through a correlation operation on the preamble signals received from the BS, selects an FA of the selected BS, and selects a random FAB from the selected FA. In step 518, the MS receives broadcast information from the selected BS. In this case, the broadcast information includes not only the system parameter information of the BS, the downlink/uplink information, and the position information necessary for an initial access to the BS, but also FA information supportable by the BS, and load information of the FABs constituting the FA. The load information indicates the number of MSs accessing each individual FAB. The MS can use the load information for FAB selection.

In step 520, the MS can determine the number of FABs of the BS depending on the received broadcast information. That is, the MS determines whether the BS to which it will make an initial access uses a frequency bandwidth broader than its own frequency bandwidth. If it does, the MS proceeds to step 522. Otherwise, the MS proceeds to step 526.

In step 522, based on the load information, the MS can reselect an optimal FA that is lower than the currently selected FA in terms of the consumed frequency capacity (i.e. the amount of consumed frequency). That is, the MS can reselect an FA having low consumed frequency capacity, and the selected FA may be the same FA as the previously selected FA. If the MS selects an FA different from the FA selected in step 516, the MS proceeds to step 524 where it selects a random FAB from the newly selected FA or selects an FAB having the minimum load according to the load information.

In step 526, the MS performs an initial access procedure to the BS using the FAB selected in step 516 or the FAB selected in step 524. In step 528, the MS performs capability negotiation such as available bandwidth negotiation and MCS (Modulation and Coding Scheme) level negotiation with the BS to which it made the initial access.

In step 530, the MS performs an authentication operation such as authentication key exchange with the BS. In step 532, the MS attempts registration to the BS. If the MS succeeds in the registration, it proceeds to step 536. However, if the MS fails in the registration, it proceeds to step 540.

In step 536, the MS performs Internet Protocol (IP) connection setup with the BS. In step 538, the MS requests new connection setup, or operates in the idle mode until it receives a paging message. In step 540, due to its registration failure, the MS operates in a sleep mode and periodically wakes up to receive only the broadcast information. When necessary, the MS returns to step 532 to attempt registration to the BS.

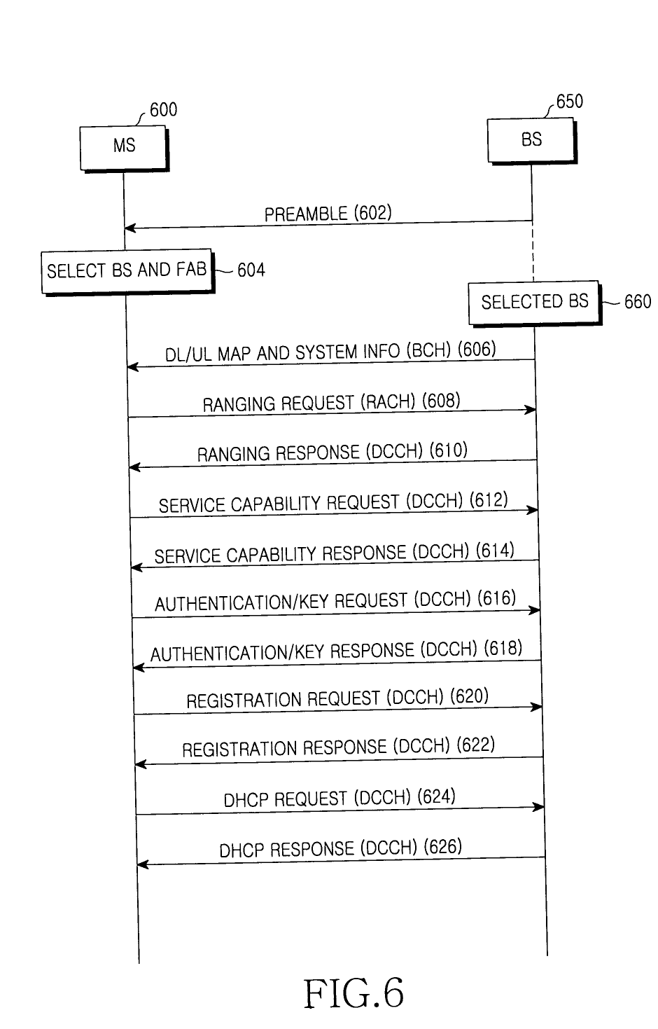

FIG. 6 is a signaling diagram illustrating a message flow for an initial operation in a frequency overlay communication system according to the first embodiment of the present invention.

Referring to FIG. 6, in step 602, an MS 600 receives a preamble from a BS 650. The MS 600 can be either an NB-MS or an EB-MS. The BS 650 can also be either an NB-BS or an EB-BS. In step 604, the MS 600 selects a BS having the highest correlation through a correlation operation on the preamble signals, and then selects an FA or an FAB for the selected BS. Herein, the newly selected BS will be called a “selected BS” 660.

In step 606, the selected BS 660 transmits broadcast information to the MS 600 over a broadcast channel (BCH). The broadcast information includes downlink frame information (DL-MAP) and uplink frame information (UL-MAP) messages, system information, and per-FAB load information. The MS 600, as it receives the broadcast information, can determine whether the selected BS 660 is an NB-BS or an EB-BS. In step 608, the MS 600 transmits a Ranging Request message to the selected BS 660 over a Random Access Channel (RACH). In step 610, the selected BS 660 transmits a Ranging Response message over a Dedicated Control Channel (DCCH) in response to the Ranging Request message.

In step 612, the MS 600, after successfully ranging, transmits a Service Capability Request message for capability negotiation to the selected BS 660 over the DCCH. In step 614, the selected BS 660 transmits a Service Capability Response message to the MS 600 in response to the Service Capability Request message. The Service Capability Response message can include information on an MCS level supportable for the MS 600.

Thereafter, in step 616, the MS 600 transmits an Authentication/Key Request message including the information necessary for user authentication to the selected BS 660. In step 618, the selected BS 660 transmits an Authentication/Key Response message including the information indicating authentication success/failure and the information necessary for encryption, to the MS 600.

In step 620, the MS 600 transmits a Registration Request message for registration to the selected BS 660. In step 622, the selected BS 660 transmits a Registration Response message to the MS 600.

In step 624, the MS 600, after successful registration, transmits a Dynamic Host Configuration Protocol (DHCP) Request message for requesting IP address allocation to the selected BS 660. In step 626, the selected BS 660 transmits a DHCP Response message to the MS 600.

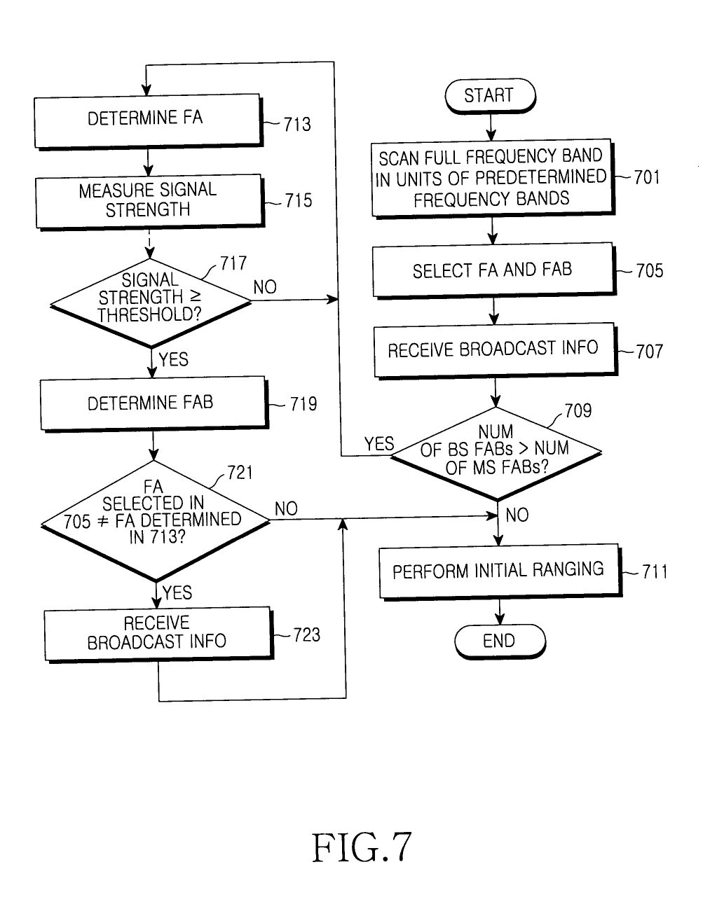

FIG. 7 is a flowchart illustrating a first initial access process performed by an MS in a frequency overlay communication system according to a second embodiment of the present invention.

Referring to FIG. 7, in step 701, the MS scans the full frequency band in units of a selected frequency band regardless of whether a BS to which it will make an access is an NB-BS or an EB-BS. Herein, the “predetermined frequency band” refers to an FAB for an NB-MS that uses a single FAB, and to an FA for an EB-MS that uses a plurality of FABs. In the NB-MS using a single FAB, the single FAB itself can be an FA. As a result of the per-FA scanning by the EB-MS, if the unit frequency band of the BS is the FAB that is less than the FA, the EB-MS can re-perform the scanning in units of FABs. The “scanning” refers to a process of performing, by the MS, a correlation operation on frequency bands corresponding to the selected frequency band while changing the center frequency. The correlation operation indicates a correlation operation on preamble signals of the frequency bands corresponding to the selected frequency band.

In step 705, the MS selects a frequency band (FA or FAB) having the highest correlation through the correlation operation, and selects a random FAB in the FA if the selected frequency band is the FA, or selects the FAB if the selected frequency band is the FAB. In step 707, the MS receives broadcast information from the selected frequency band (FAB), and recognizes to which BS the selected frequency band corresponds, based on the received broadcast information. The broadcast information is broadcast in units of FABs, and includes information on the frequency band used by the BS, system parameter information, downlink/uplink information, and position information necessary for an initial access to the BS, i.e. frame slot information. In addition, the broadcast information can also include load information indicating the number of MSs accessing each individual frequency band. In the above processes, the MS performs frequency band selection and cell acquisition to receive the broadcast information. The MS may also determine to which BS the selected frequency band corresponds, according to the previously-recognized frequency band information for each individual BS, without receiving the broadcast information from the BS.

In step 709, the MS determines whether the BS uses a frequency bandwidth broader than its own frequency bandwidth. If it does, i.e. if the number of FABs used by the BS is greater than the number of FABs used by the MS, the MS proceeds to step 713. Otherwise, the MS proceeds to step 711, where the MS performs initial ranging to the BS using the downlink information received through the FAB frequency band selected in step 705. If the FA of the BS and the FA of the MS are the same frequency band, the MS selects FABs in the FA in order of a low load, or if the signal strength, such as Carrier-to-Interference (C/I) or Signal to Interference and Noise Ratio (SINR), satisfies a criterion, the MS can determine it as a frequency band for initial access. If the MS fails in the initial ranging, it repeats step 701 and the successive steps, or selects another FAB in step 705 and repeats the successive steps.

In step 713, the MS can select an FA different from the currently selected FA. In this case, the MS determines an FA having sufficient available frequency resources depending on the load information. The MS can select the same FA as the FA selected in step 705. In step 715, the MS measures strength of a signal received through the determined FA. Herein, the signal strength can be determined in carrier-to-interference ratio (C/I) or signal-to-interference and noise ratio (SINR).

If it is determined in step 717 that the measured signal strength is higher than or equal to a threshold, the MS proceeds to step 719. Otherwise, the MS returns to step 713. It should be noted that steps 715 and 717 can be omitted according to system realization.

In step 719, the MS selects a random FAB among the FABs in the FA. During the FAB selection, the MS may select an optimal FAB using the per-FAB load information. Alternatively, the FAB selection of step 719 may be performed before the signal strength measurement of step 715. In addition, step 719 may be omitted for the NB-MS, which has an FA composed of one FAB. A method for selecting the FAB will be described in more detail below. In step 721, the MS determines whether the FA selected in step 705 is different from the FA selected in step 713. If it is determined that the FAs are different, the MS proceeds to step 723. However, if the FAs are equal, the MS returns to step 711. In step 723, the MS re-receives the broadcast information through the new FAB in the FA, and then returns to step 711.

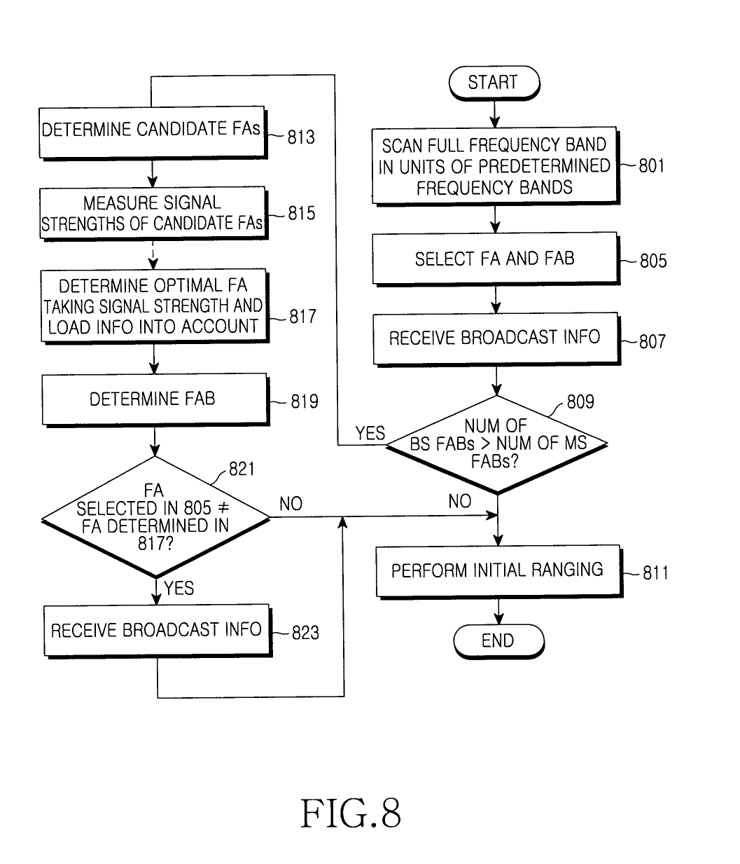

FIG. 8 is a flowchart illustrating a second initial access process performed by an MS in a frequency overlay communication system according to the second embodiment of the present invention.

Referring to FIG. 8, steps 801 to 811 are equal to steps 701 to 711 of FIG. 7, so a description thereof will be omitted.

In step 809, the MS determines whether the BS uses a frequency bandwidth broader than its own frequency bandwidth. If it does, i.e. if the number of FABs used by the BS is greater than the number of FABs used by the MS, the MS proceeds to step 813. In step 813, the MS determines FAs having a consumed frequency band capacity (i.e. the amount of consumed frequency bands) that satisfies a selected criterion, as candidate FAs to which it will make an initial access, depending on the recognized load information in the received broadcast information. The number of the candidate FAs is determined based on a selected frequency band capacity threshold. In step 815, the MS measures preamble signal strength for each of the candidate FA. In step 817, the MS determines an optimal FA considering both the measured signal strength and the load information.

In step 819, the MS determines one of FABs in the determined optimal FA as an FAB. The FAB can be either determined randomly or as an FAB having the minimum load taking the per-FAB load information into consideration. In step 821, the MS determines whether the FA selected in step 805 is different from the FA selected in step 817. If different, the MS proceeds to step 823. However, if the FAs are equal, the MS returns to step 811. In step 823, the MS re-receives the broadcast information through the new FAB in the FA, and then returns to step 811.

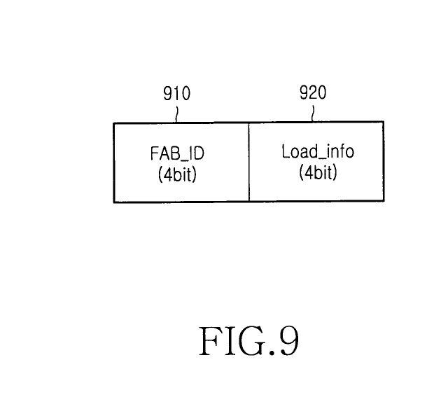

FIG. 9 is a diagram illustrating a preferred format of FAB load information according to the present invention.

Referring to FIG. 9, all BSs transmit their own load information for each individual frequency band to an MS along with broadcast information. In the present invention, a size of the FAB load information is expressed with, for example, 1 byte, and the FAB load information includes a 4-bit FAB_ID field 910 and a 4-bit Load_info field 920. For example, when an EB-BS uses a 120 MHz frequency band (i.e. FA) and the 120 MHz frequency band is divided into 10 MHz FABs, the EB-BS transmits per-FAB load information, i.e. 12-byte per-FAB load information, to the MS along with the broadcast information. Therefore, the FAB_ID field 910 is an indication field used for distinguishing each FAB, and the Load_info field 920 is a field indicating per-FAB load information. The per-FAB load information can be represented in various manners, and the MS can select an FAB according to the per-FAB load information.

A description will now be made of a method for selecting by an MS an optimal FA according to the per-FAB load information.

First, there is a method in which the consumed resource capacity (i.e. the amount of consumed resources) of each FA is determined according to load information for each individual FAB constituting the FA, i.e. the sum of loads, and an MS selects FAs in order of the low per-FA consumed resource capacity. In other words, the order is determined according to the consumed resource capacity for each individual FA, and the MS sequentially selects FAs in order of an FA having the greatest sum of Load_info (i.e. the lowest consumed resource capacity).

Next, there is a method in which FAs are grouped into several groups, and an MS randomly selects one of the FAs by selecting the group having the greatest Load_info value. However, in the above methods, multiple MSs may concentrate in one FA or FAB at a particular time.

In order to solve this problem, there is provided a method in which an MS selects an FA based on a probabilistic weight. Equation (1) is as follows:

$${p}_{i} = \frac{{Load\_info}_{i}}{\sum ( Load\_info )} \qquad ( 1 )$$

In Equation (1), pᵢ denotes a probability that an MS will select an i^{th} FA, Load_infoᵢ denotes load information of an i^{th} FA, and Σ(Load_info) denotes the sum of loads of the FAs. Each per-FA pᵢ determined using Equation (1) is determined as each per-FA weight. That is, this method sets the probability that the MS will select an FA with a greater Load_info value to be higher than the probability that the MS will select an FA with a smaller Load_info value, thereby preventing the concentration problem that the MS unconditionally selects only the FA with the greater Load_info value. As a result, the MS can also select an FA with a small Load_info value even at a low probability, bringing a per-FA load balancing effect on a long term basis while MSs select FAs. As a method in which the MS selects an FAB after selecting an optimal FA, there is a possible method for randomly selecting the FAB, or selecting the FAB considering the per-FAB load information.

A description will now be made of the optimal FA determining method according to the second embodiment of the present invention, considering the method of selecting an FA based on the probabilistic weight.

An MS selects N candidate FAs according to load information acquired from received broadcast information. If load information for individual FAs is defined as L₁, L₂, L₃, . . . , L_{N} (the greater value indicates the lower amount of consumed resources (or the lower consumed resource capacity)), and received signal strengths for the individual FAs are defined as S₁, S₂, S₃, . . . , S_{N} (the greater value indicates the higher signal strength), the optimal FA can be determined by the following Equation (2):

$${n}_{suitable} = arg {max}_{n} max {lL}_{n} \cdot {sS}_{n} \qquad ( 2 )$$

In Equation (2), nε{1,2,3, . . . N}, and l and s denote weights for load information and received signal strength, respectively. The weight s for the received signal strength is a weight selected for the individual received signal strength. The MS selects n having the maximum value, i.e. an optimal FA, in accordance with Equation (2).

As can be understood from the foregoing description, the present invention defines an initial operation of an NB-MS and an EB-MS in a frequency overlay communication system, thereby efficiently providing high-speed multimedia service for the next generation mobile communication system.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for performing an initial operation of a mobile station (MS) that uses a first frequency band, in a frequency overlay communication system having the first frequency band including a plurality of sub-frequency bands, the method comprising the steps of:
performing correlation on a full frequency band in units of the first frequency band;
receiving broadcast information through a frequency band having a maximum correlation value; and
performing an initial access to a base station (BS) through the frequency band having the maximum correlation value if a frequency bandwidth of the BS acquired from the broadcast information is narrower than or equal to a selected frequency bandwidth of the MS.

2. The method of claim 1, further comprising:
performing service capability negotiation with the BS;
performing an authentication operation;
performing a registration operation; and
performing Internet protocol (IP) connection setup after registering in the BS.

3. The method of claim 1, wherein the correlation on the full frequency band in units of the first frequency band further includes:
(1) performing correlation by the first frequency band;
(2) shifting by the first frequency band, shifting a center frequency, and performing correlation; and
(3) repeating the step (2) until the correlation over the full frequency band is completed.

4. The method of claim 1, wherein the broadcast information is received through any one of sub-frequency bands of the frequency band having the maximum correlation value.

5. The method of claim 4, wherein the broadcast information includes downlink frame information (DL-MAP) and uplink frame information (UL-MAP).

6. The method of claim 1, wherein the broadcast information includes frequency band information of the BS.

7. The method of claim 1, wherein the broadcast information includes load information for each individual sub-frequency band.

8. The method of claim 1, wherein the initial access includes a process of performing a ranging procedure through any one of sub-frequency bands of the frequency band having the maximum correlation value.

9. The method of claim 1, further comprising:
selecting a second frequency band that is equal in bandwidth to the first frequency bandwidth but different in center frequency from the first frequency bandwidth while considering load information included in the broadcast information, if a frequency bandwidth of the BS acquired from the broadcast information is broader than the first frequency bandwidth of the MS; and
performing ranging through any one of sub-frequency bands of the second frequency band.

10. The method of claim 9, wherein the one sub-frequency band is a sub-frequency band having a minimum load as compared to a plurality of sub-frequency bands.

11. A method for performing an initial operation of a mobile station (MS) that uses any one of a plurality of sub-frequency bands, in a frequency overlay communication system having a first frequency band including a plurality of the sub-frequency bands having different center frequencies, the method comprising the steps of:
performing correlation on a full frequency band in units of the selected one sub-frequency band;
receiving broadcast information through a sub-frequency band having a maximum correlation value; and
sending a ranging request to a base station (BS) using band information acquired from the broadcast information.

12. The method of claim 11, further including:
performing service capability negotiation with the BS upon receipt of a ranging response in response to the ranging request;
performing an authentication operation;
performing a registration operation; and
performing Internet protocol (IP) connection setup after registering in the BS.

13. The method of claim 11, wherein the correlation includes a process of selecting a BS having a maximum correlation value using a preamble signal received from a particular BS.

14. The method of claim 11, wherein the broadcast information includes load information for each individual sub-frequency band.

15. The method of claim 11, wherein the band information includes time slot information of an uplink frame and frequency band information necessary for performing ranging.

16. The method of claim 11, wherein the ranging request is transmitted over a random access channel.

17. A system for performing an initial access in a frequency overlay communication system, the system comprising:
a base station (BS) using at least one first frequency band, for broadcasting load information indicating an amount of consumed resources for an at least one sub-frequency band, wherein the first frequency band is a broad frequency band and includes at least one sub-frequency band which is a narrow frequency band; and
a mobile station (MS) for determining any one sub-frequency band in the first frequency band, considering the load information received from the BS.

18. The system of claim 17, wherein the MS performs initial ranging through the any one sub-frequency band.

19. The system of claim 17, wherein the MS determines any one sub-frequency band in the first frequency band as a frequency band used for performing an initial access, considering both the load information and reference signal strength of the BS.

20. The system of claim 17, wherein the MS scans a full frequency band in units of a selected frequency band for receipt of the load information, selects a frequency band having a highest reference signal strength among a plurality of frequency bands, and receives broadcast information including the load information from the selected frequency band.

21. The system of claim 17, wherein the MS scans a full frequency band in units of a selected frequency band for receipt of the load information, selects any one frequency band among the sub-frequency bands, and receives broadcast information including the load information from the selected frequency band.

22. The system of claim 21, wherein the broadcast information includes downlink frame information (DL-MAP) and uplink frame information (UL-MAP).

23. The system of claim 21, wherein the load information includes an identifier field used for distinguishing the sub-frequency bands, and a load field indicating load information associated with an identifier of each sub-frequency band.

24. The system of claim 17, wherein the MS selects the sub-frequency bands of the BS in order of a low load if the MS uses one of sub-frequency bands of the BS, and if the selected sub-frequency band satisfies a reference, the MS determines the selected sub-frequency band as a frequency band for initial ranging.

25. The system of claim 24, wherein the reference includes a carrier-to-interference ratio (C/I).

26. The system of claim 24, wherein the MS selects the sub-frequency bands of the BS while changing a center frequency.

27. The system of claim 17, wherein the MS selects sub-frequency bands in the first frequency band in order of a low load if the MS uses the same frequency band as the first frequency band of the BS, and the MS determines the selected sub-frequency band as a frequency band for initial ranging if the selected sub-frequency band satisfies a reference.

28. The system of claim 17, wherein the MS divides the second frequency band in units of the first frequency band, calculates a correlation between each of the divided frequency bands and the first frequency band, and determines a frequency band having a maximum correlation value as a frequency band for initial ranging, if the MS uses a second frequency band broader than the first frequency band of the BS.

29. The system of claim 17, wherein the MS determines a weight for each individual sub-frequency band with a ratio of a load of each sub-frequency band in the first frequency band to a total load of all sub-frequency bands, and determines a frequency band for initial ranging considering a probabilistic load for each individual sub-frequency band, determined by the weight.

30. A method for performing an initial access of a mobile station (MS) in a frequency overlay communication system having at least one broad frequency band and includes at least one narrow sub-frequency band, the method comprising the steps of:
receiving, from a base station (BS), load information indicating an amount of consumed resources for the at least one sub-frequency band;
determining any one sub-frequency band in the first frequency band considering the load information; and
performing an initial access to the BS through the determined sub-frequency band.

31. The method of claim 30, wherein the determining step further includes determining, as a frequency band used for performing the initial access, any one sub-frequency band in the first frequency band, considering the load information and reference signal strength for each individual frequency band of the BS.

32. The method of claim 31, further including:
scanning, by the MS, a full frequency band in units of a selected frequency band;
selecting a frequency band having a highest reference signal strength among a plurality of frequency bands; and
receiving broadcast information including the load information from the selected frequency band.

33. The method of claim 31, further including:
scanning, by the MS, a full frequency band in units of a selected frequency band;
randomly selecting a sub-frequency band; and
receiving broadcast information including the load information from the selected frequency band.

34. The method of claim 32, wherein the broadcast information includes downlink frame information (DL-MAP) and uplink frame information (UL-MAP).

35. The method of claim 32, wherein the load information includes an identifier field used for distinguishing the sub-frequency bands, and a load field indicating load information associated with an identifier of each sub-frequency band.

36. The method of claim 30, wherein if the MS uses only one of the sub-frequency bands of the BS, the step of determining a frequency band used for performing the initial access further includes:
selecting sub-frequency bands of the BS in order of a low load; and
determining the selected sub-frequency band as a frequency band used for the initial access, if the selected sub-frequency band satisfies a reference.

37. The method of claim 36, wherein the reference includes a carrier-to-interference ratio (C/I).

38. The method of claim 36, wherein the selecting step further includes selecting the sub-frequency bands of the BS while changing a center frequency of the MS.

39. The method of claim 30, wherein if the MS uses an identical frequency band as the first frequency band of the BS, the step of determining a frequency band used for performing the initial access further includes:
selecting sub-frequency bands in the first frequency band in order of a low load; and
determining the selected sub-frequency band as a frequency band used for the initial access, if the selected sub-frequency band satisfies a reference.

40. The method of claim 30, wherein if the MS uses a second frequency band broader than the first frequency band of the BS, the step of determining a frequency band used for performing the initial access further includes:
dividing the second frequency band in units of the first frequency band;
calculating a correlation between each of the divided frequency bands and the first frequency band; and
determining a frequency band having a maximum correlation value as a frequency band used for the initial access.

41. The method of claim 30, wherein the determining step further includes determining a weight for each individual sub-frequency band with a ratio of a load of each sub-frequency band in the first frequency band to a total load of all sub-frequency bands, and determining a frequency band used for performing an initial access, considering a probable load for each individual sub-frequency band, determined by the weight.
